(19) United States
(12) Patent Application Publication
(10) Pub. No.: US 2005/0160459 A1
(43) Pub. Date: Jul. 21, 2005

(54) Advertisement managing method and broadcasting apparatus

(75) Inventors: Seiichi Mashimo, Kawasaki (JP); Hiroyuki Hatta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/077,154

(22) Filed: Mar. 11, 2005

Related U.S. Application Data
(63) Continuation of application No. PCT/JP04/01137, filed on Feb. 4, 2004.

(30) Foreign Application Priority Data
Mar. 27, 2003 (JP) 2003-088143

(51) Int. Cl. H04N 7/025; G06F 13/00; H04N 5/445; G06F 3/00; H04N 7/10

(52) U.S. Cl. 725/46; 725/34; 725/35

(57) ABSTRACT

An advertisement managing method for a broadcasting apparatus to transmit a broadcast, comprises a data acquisition information receiving step receiving, from a broadcast receiver, data acquisition information about an acquisition of data relating to music contained in the broadcast by the broadcast receiver, a preference information accumulating step accumulating the data acquisition information received in the data acquisition information receiving step as music preference information of a viewer, and a background music changing step changing background music of an advertisement based on the preference information prior to broadcasting the advertisement.

### CROSS-REFERENCE TO RELATED APPLICATIONS

This is a U.S. continuation application filed under 35 USC 111(a) claiming benefit under 35 USC 120 and 365(c) of PCT application JP2004/001137, filed on Feb. 4, 2004, which claims priority to Application Ser. No. 2003-088143, filed in Japan on Mar. 27, 2003. The foregoing applications are hereby incorporated herein by reference.

### BACKGROUND OF THE INVENTION

1. Field of the Invention

The present invention relates to an advertisement managing method and a broadcasting apparatus.

2. Description of the Related Art

Broadcasting stations have been broadcasting commercials with contents thereof (descriptions and images of a product and/or service) and background music (hereinafter referred to as BGM).

These commercials are usually created by, for example, commercial creators so as to efficiently attract audiences and give a good impression of the product and/or service.

In the meantime, systems for providing commercials that match preference of individual viewers are proposed (see, for example, Japanese Patent Laid Open Publication No. 2002-7873).

However, such methods and systems are not desirable in that the BGM of the commercials does not always match the preference of the viewers, and therefore fails to achieve expected effects. Specifically, the commercials created with these methods and systems are not able to attract the viewers or to give a good impression of the product and/or service.

### SUMMARY OF THE INVENTION

An object of the present invention is therefore to provide a method for broadcasting an advertisement with background music that matches the preference of a viewer.

To overcome the above drawbacks, the present invention provides an advertisement managing method for a broadcasting apparatus to transmit a broadcast, comprising a data acquisition information receiving step receiving, from a broadcast receiver, data acquisition information about an acquisition of data relating to music contained in the broadcast by the broadcast receiver, a preference information accumulating step accumulating the data acquisition information received in the data acquisition information receiving step as music preference information of a viewer, and a background music changing step changing background music of an advertisement based on the preference information prior to broadcasting the advertisement.

According to the present invention, the advertisement can be broadcasted with the background music that matches the preference of a viewer.

In order to overcome above drawbacks, the present invention may also be embodied in the form of a broadcasting apparatus to transmit a broadcast.

### BRIEF DESCRIPTION OF THE DRAWINGS

FIG. 1 is a diagram showing an example of a system for implementing the present invention;

FIG. 2 is a diagram showing an example of hardware of a broadcasting apparatus;

FIG. 3 is a diagram showing an example of functional structure of the broadcasting apparatus;

FIG. 4 shows an example of a user management DB;

FIG. 5 shows an example of a table of a music list DB;

FIG. 6 is a flowchart showing an example of bookmark accumulating operations;

FIG. 7 shows an example of a table of a bookmark DB;

FIG. 8 is a flowchart showing an example of above-threshold music detecting operations;

FIG. 9 shows an example of a change notice;

FIG. 10 is a flowchart showing an example of BGM changing operations;

FIG. 11 shows an example of a table of a commercial material DB;

FIG. 12 shows another example of the table of the bookmark DB;

FIG. 13 shows still another example of the table of the bookmark DB;

FIG. 14 is a flowchart showing an example of above-threshold genre detecting operations;

FIG. 15 shows another example of the change notice; and

FIG. 16 shows an example of a commercial broadcast.

### DETAILED DESCRIPTION OF THE PREFERRED EMBODIMENT

Hereinafter, exemplarily embodiments of the present invention are described with reference to the accompanying drawings.

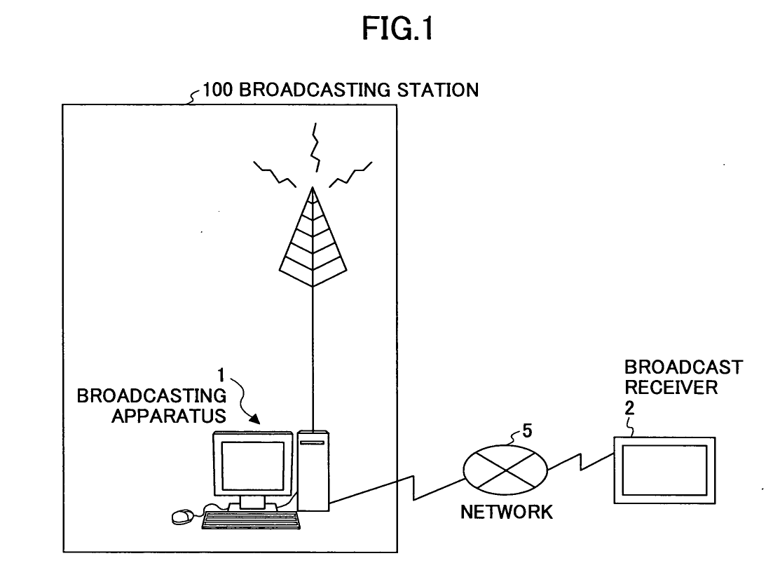

FIG. 1 is a diagram showing an example of a system for implementing the present invention. In FIG. 1, the system for implementing the present invention comprises a broadcasting station 100 having a broadcasting apparatus 1, and a broadcast receiver 2 connected to the broadcasting station 100 via a network 5.

The broadcasting apparatus 1 in the broadcasting station 100, as is described later, provides streaming broadcasts of programs such as dramas and commercials, and also transmits data of music (music data) in file formats to the broadcast receiver 2 (to be described later) so that a viewer (hereinafter also referred to as user) can preview or purchase the music via the broadcast receiver 2.

The broadcast receiver 2 receives the programs and commercials broadcasted by the broadcasting apparatus 1, and also transmits information (hereinafter referred to as bookmark information), which indicates that the user has downloaded, previewed, or purchased the music data, to the broadcasting apparatus 1 via the network 5 in response to the user's request. A specific example of the broadcast receiver 2 is a digital television.

The broadcasting apparatus 1 receives and accumulates the bookmark information, changes BGM of a commercial based on the accumulated bookmark information, and broadcasts the commercial.

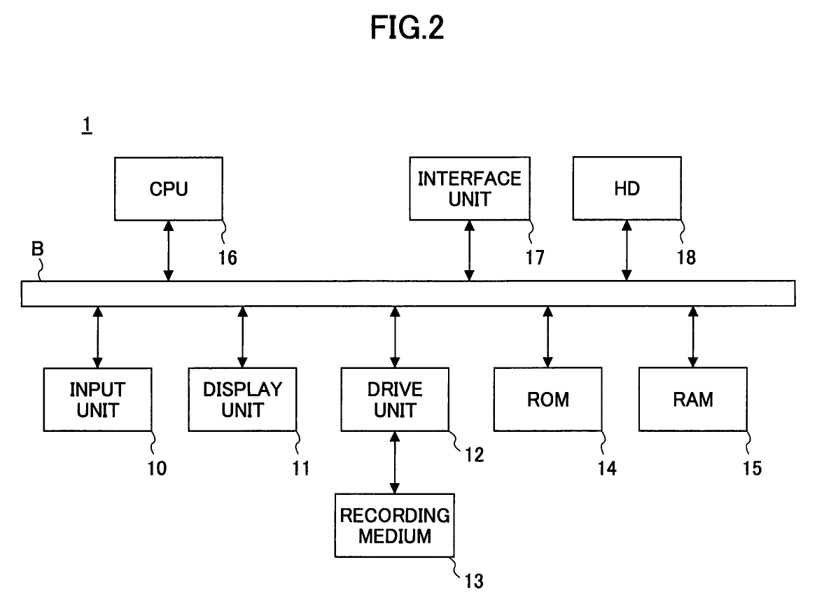

An example of hardware of the broadcasting apparatus 1 is provided below with reference to FIG. 2.

FIG. 2 is a diagram showing an example of hardware of the broadcasting apparatus 1.

The hardware of the broadcasting apparatus 1 shown in FIG. 2 comprises an input unit 10, a display unit 11, a drive unit 12, a recording medium 13, a ROM (Read Only Memory) 14, a RAM (Random Access Memory) 15, a CPU (Central Processing Unit) 16, an interface unit 17, a HD (Hard Disk) 18, and a bus B interconnecting these units.

The input unit 10 comprises a keyboard and a mouse, which are used by an operator of the broadcasting apparatus 1 to input various control signals in the broadcasting apparatus 1.

The display unit 11 comprises a display, which is used by the operator of the broadcasting apparatus 1 to view various information items.

The interface unit 17 is an interface for connecting the broadcasting apparatus 1 to the network 5.

A commercial management program is provided in the form of the recording medium 13 such as a CD-ROM or is downloaded via the network 5 so as to execute bookmark accumulating operations, track and/or genre detecting operations and BGM changing operations, which are described later. When the recording medium 13 is loaded in the drive unit 12, the commercial management program is installed in the ROM 14 through the drive unit 12.

The ROM 14 stores data, the commercial management program and the like. The RAM 15 reads out the commercial management program when the broadcasting apparatus 1 is started, and holds the program therein. The CPU 16 executes operations according to the commercial management program held by the RAM 15.

The HD 18 stores data, files, and later-described various databases (hereinafter, referred to as DBs).

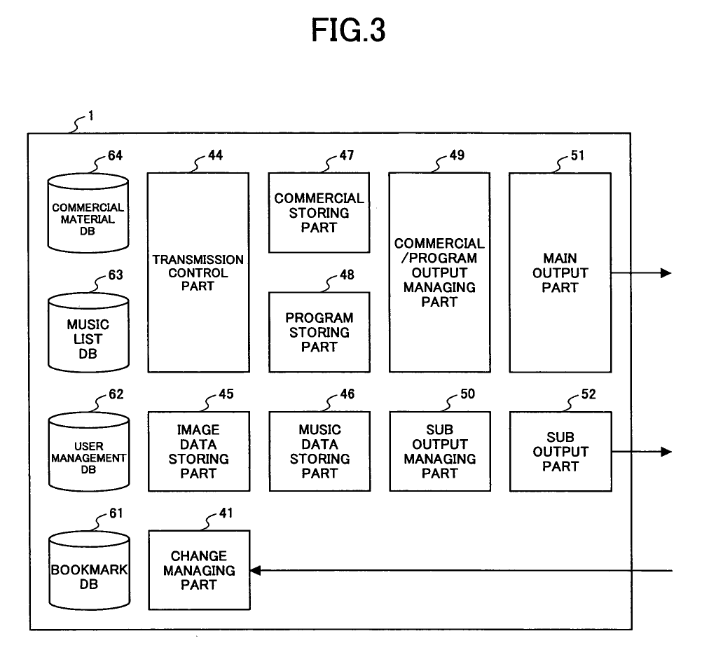

An example of functional structure of the broadcasting apparatus 1 is provided below with reference to FIG. 3.

FIG. 3 is a diagram showing an example of the functional structure of the broadcasting apparatus 1.

In FIG. 3, the broadcasting apparatus 1 comprises a change managing part 41, a transmission control part 44, an image data storing part 45, a music data storing part 46, a commercial storing part 47, a program storing part 48, a commercial/program output managing part 49, a sub output managing part 50, a main output part 51, a sub output part 52, a bookmark DB 61, a user management DB 62, a music list DB 63, and a commercial material DB 64.

The change managing part 41 receives the bookmark information from the broadcast receiver 2 and accumulates the bookmark information in the bookmark DB 61, and detects a track and/or genre above a predetermined threshold based on the accumulated bookmark information in the bookmark DB 61 to inform the transmission control part 44.

The transmission control part 44 changes BGM of a commercial acquired from the commercial storing part 47 based on the information sent by the change managing part 41, and stores the commercial with another BGM in the commercial storing part 47.

The image data storing part 45 stores image data used for commercials, while the music data storing part 46 stores music data used for BGM of the commercials. Although the broadcasting apparatus 1 of FIG. 3 has the image data storing part 45 in view of broadcasts for digital television, the broadcasting apparatus 1 does not necessarily include the image data storing part 45 if the intended use is only for radio broadcasts. The following description is, however, based on the case that the broadcasting apparatus 1 is used for digital television broadcasts in order to simplify the explanation. This is not intended to limit the scope of the invention.

The commercial storing part 47 stores commercials scheduled to be broadcasted, while the program storing part 48 stores programs scheduled to be broadcasted.

The commercial/program output managing part 49 sends a commercial scheduled to be broadcasted and a program scheduled to be broadcasted to the main output part 51 respectively from the commercial storing part 47 and the program storing part 48 according to a predetermined schedule, and requests an output thereof. Simultaneously, the commercial/program output managing part 49 acquires music data to be used for the commercial and program from the music data storing part 46, and provides the data to the main output part 51.

The main output part 51 provides streaming broadcasts of the commercial and/or program in response to the request from the commercial/program output managing part 49.

The sub output managing part 50 acquires music data for music related to the commercial and/or program from the music data storing part 46, sends the music data to the sub output part 52 in conjunction with the commercial/program output managing part 49, and requests an output thereof.

The sub output part 52 transmits the music data in a file format to the broadcast receiver 2 in response to the request from the sub output managing part 50.

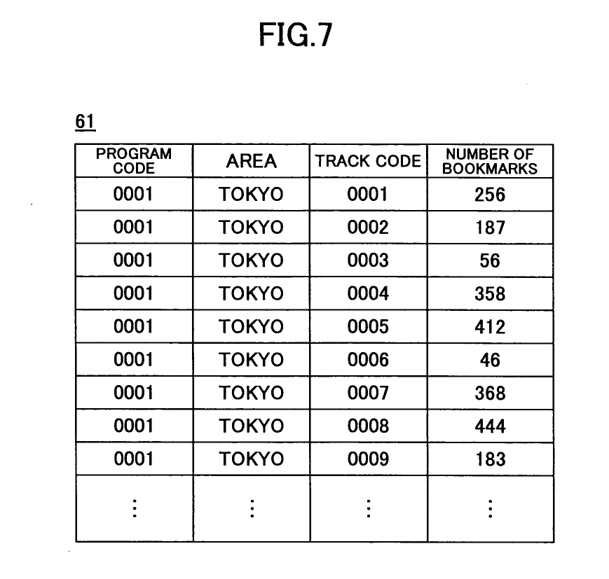

The bookmark DB 61 stores the bookmark information. The bookmark DB 61 is described later in detail with reference to FIGS. 7, 12 and 13.

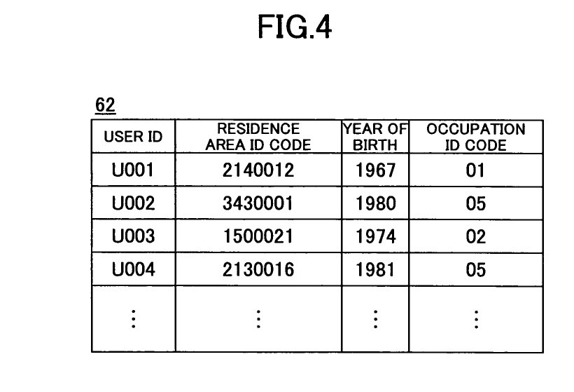

The user management DB 62 stores information on users who watch broadcasts using the broadcast receiver 2. The user management DB 62 is described later in detail with reference to FIG. 4.

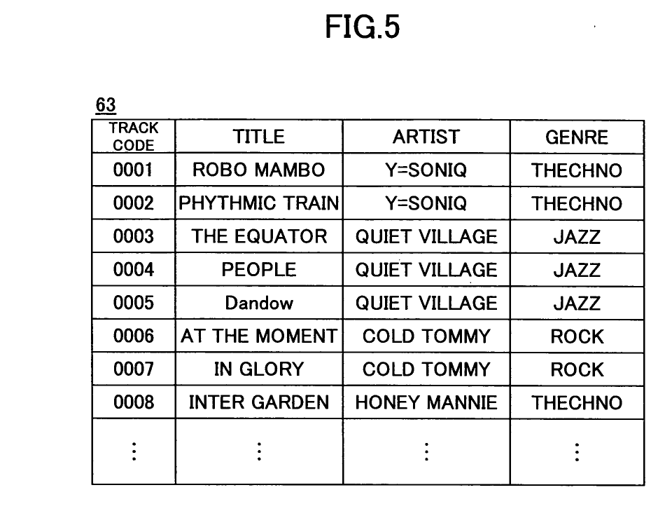

The music list DB 63 stores information on music. The music list DB 63 is described later in detail with reference to FIG. 5.

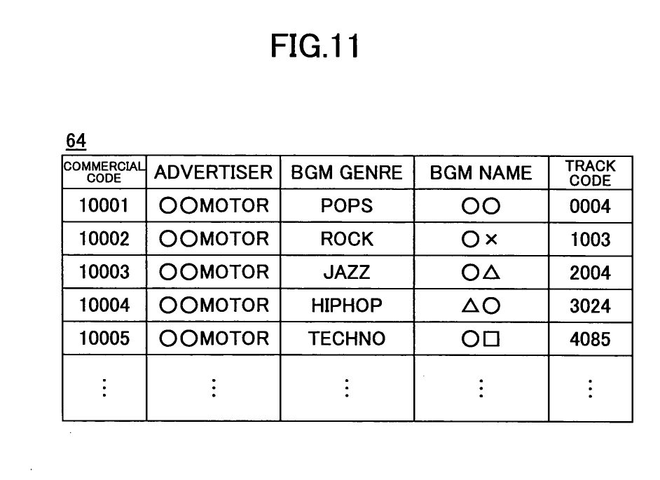

The commercial material DB 64 stores information on commercials and music of the commercials. The commercial material DB 64 is described later in detail with reference to FIG. 11.

An example of the user management DB 62 is provided below with reference to FIG. 4.

FIG. 4 shows an example of the user management DB.

The user management DB 62 includes the table shown in FIG. 4. The table contains items such as user ID, residence area ID code, year of birth, and occupation.

A cell for the user ID stores an identifier for identifying a user who watches a broadcast.

A cell of the residence area ID code stores an ID code for identifying the residence area of the user. A post code is an example of the residence area ID code. Having the residence area ID code makes it possible, for example, to count the number of pieces of bookmark information for each prefecture or each city so as to change BGM of a commercial on an area basis.

A cell of the year of birth stores the year of birth of the user. Having the year of birth makes it possible, for example, to count the number of pieces of bookmark information by age so as to change BGM of a commercial on an age basis.

A cell for the occupation ID code stores an ID code for identifying the occupation of the user. Having the occupation ID code makes it possible, for example, to count the number of pieces of bookmark information for each occupation code so as to change BGM of a commercial on an occupation basis. The occupation ID code is associated with an occupation. For example, “01”, “02”, . . . in the cells for the occupation ID code in FIG. 4 are respectively associated with company employee (administrative division), company employee (engineering division), . . . .

An example of the music list DB 63 is provided below with reference to FIG. 5.

FIG. 5 shows an example of a table of the music list DB 63.

The music list DB 63 includes the table shown in FIG. 5. The table contains items such as track code, title, artist, and genre.

A cell for the track code stores an ID code for identifying music.

A cell for the title stores the title of the music.

A cell for the artist stores the name of the artist who plays the music.

A cell for the genre stores the genre of the music. For simplifying the explanation, words of the music genres such as JAZZ and TECHNO are stored in the cells for the genre in FIG. 5. However, genre ID codes for identifying music genres (e.g. 0001 for JAZZ, 0002 for TECHNO) may be used instead. This applies to the genres that follow.

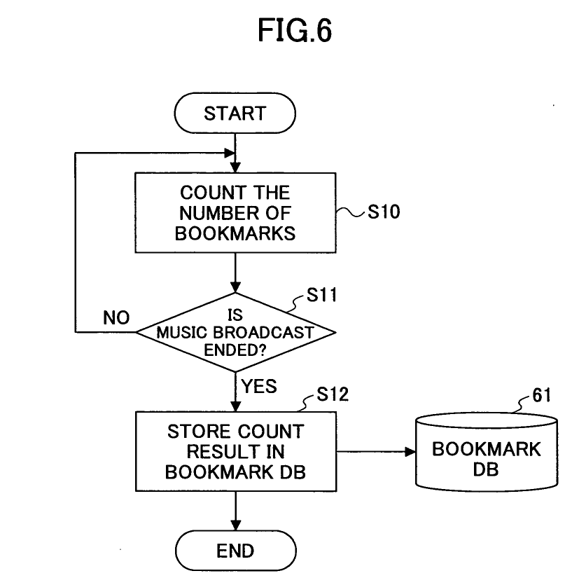

An example of bookmark accumulating operations is provided below with reference to FIG. 6.

FIG. 6 is a flowchart showing an example of the bookmark accumulating operations.

The change managing part 41 starts the following operations upon receiving a notice indicating that a commercial and/or program is output from the commercial/program output managing part 49 and a music-related broadcast is started (e.g. a broadcast of music in a music show is started, or a broadcast of music as BGM of a program is started).

In step S10, the change managing part 41 receives bookmark information transmitted from the broadcast receiver 2, and counts the number of pieces of bookmark information.

The process proceeds from step S10 to step S11, in which the change managing part 41 determines whether the music-related broadcast is ended. If the change managing part 41 determines that the music-related broadcast is ended (if Yes in step S11), the process proceeds to step S12. Otherwise, if the change managing part 41 determines that the music-related broadcast is not ended (if No in step S11), the operation returns to step S10.

For instance, when the change managing part 41 receives a notice indicating that the music-related broadcast is ended from the commercial/program output managing part 49, the change managing part 41 determines that the music-related broadcast is ended.

In step S12, the change managing part 41 stores a count result of the bookmark information in the bookmark DB 61.

### First Embodiment

### Area

An example of the bookmark DB 61 is given with reference to FIG. 7.

FIG. 7 shows an example of a table of the bookmark DB 61.

The bookmark DB 61 includes the table shown in FIG. 7. The table contains items such as program code, area, track code, and the number of bookmarks.

A cell for the program code stores an ID code for identifying a program during which music is broadcasted.

A cell for the area stores the area of a user who transmits the bookmark information using the broadcast receiver 2. The area is a prefecture, a city or the like.

For instance, the change managing part 41 identifies the area of the user who transmits the bookmark information by referring to the residence area ID codes in the user management DB 62.

A cell for the track code stores an ID code for identifying music.

A cell for the number of bookmarks stores the number of pieces of bookmark information.

As shown in FIG. 7, the change managing part 41 counts the number of pieces of bookmark information with respect to program codes, areas and track codes, and stores the result in the bookmark DB 61.

Associating the number of bookmarks with the program code makes it possible to know preferences of viewers who watch the program, change BGM of a commercial to be broadcasted during the program, and broadcast the commercial.

Also, associating the number of bookmarks with the area makes it possible to know preferences of viewers who watch the program in the area, change BGM of a commercial to be broadcasted during the program, and broadcast the commercial.

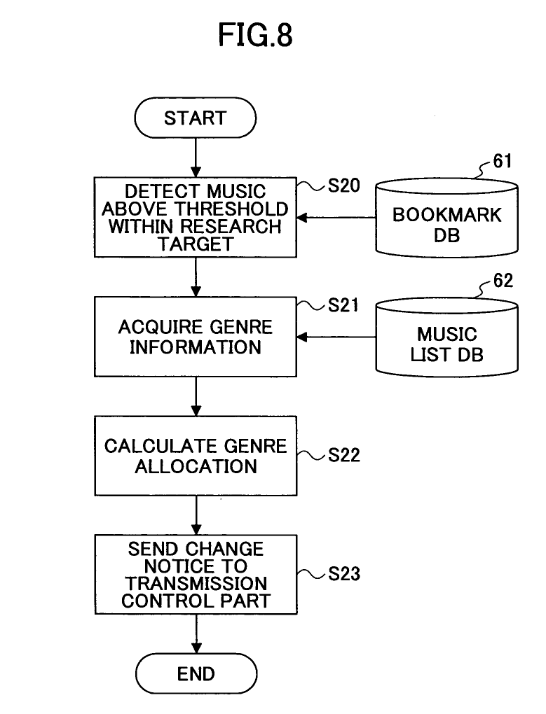

An example of operations for detecting music above a threshold is provided below with reference to FIG. 8.

FIG. 8 is a flowchart showing an example of the above-threshold music detecting operations.

In step S20, the change managing part 41 detects music above a threshold within a research target from the bookmark DB 61.

The research target is specified, for example, by program codes or areas. The research target is set based on information, which may be acquired by the change managing part 41, such as direct inputs from the operator of the broadcasting apparatus 1, or research target information defined in a research target definition file.

Likewise, the threshold is set based on information, which may be acquired by the change managing part 41, such as direct inputs from the operator of the broadcasting apparatus 1, or threshold information defined in a threshold definition file.

For instance, when the research target is program code “0001” with the area “Tokyo” and the threshold is “music with 300 or more bookmarks”, the change managing part 41 searches the table of the bookmark DB 61 based on these search conditions and acquires a track code of the music that meets the conditions as above-threshold music. In the case of the table of the bookmark DB 61 shown in FIG. 7, the track codes 0004, 0005, 0007 and 0008 are detected as above-threshold music.

The process proceeds from step S20 to step S21, in which the change managing part 41 acquires genre information of the music detected in step S20 from the music list DB 63.

For example, when the track codes 0004, 0005, 0007 and 0008 are detected in step S20, the change managing part 41 refers to the music list DB 63 to acquire the genre information of the music respectively as JAZZ, JAZZ, ROCK and TECHNO.

The process proceeds from step S21 to step S22, in which the change managing part 41 calculates the genre allocation of the above-threshold music based on the genre information acquired in step S21.

For example, when track code 0004=JAZZ, track code 0005=JAZZ, track code 0007=ROCK and track code 0008=TECNO in step S21, the genre allocation calculated by the change managing part 41 is JAZZ:ROCK:TECNO=2:1:1:1.

The process proceeds from step S22 to step S23, where the change managing part 41 sends a notice (hereinafter referred to as change notice) that directs a BGM change for a commercial to the transmission control part 44.

These operations shown in FIG. 8 are thus performed to detect music above a threshold on an area basis, calculate the genre allocation of the music, and inform the transmission control part 44 of a BGM change for a commercial.

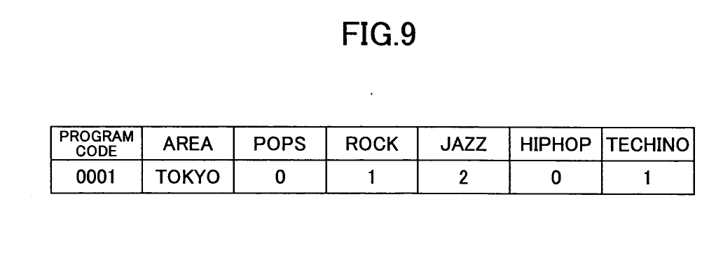

An example of the change notice is described below with reference to FIG. 9.

FIG. 9 shows an example of the change notice.

The change notice shown in FIG. 9 contains a program code, an area for which a commercial is changed, and a genre allocation of music.

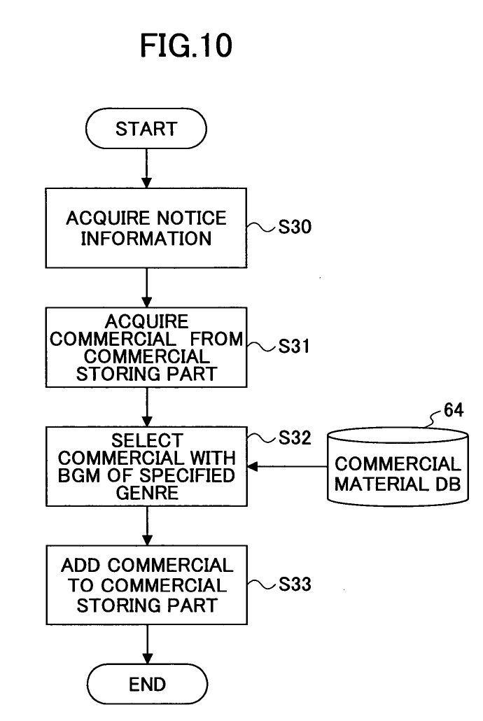

An example of BGM changing operations is described below with reference to FIG. 10.

FIG. 10 is a flowchart showing an example of the BGM changing operations.

When the transmission control part 44 receives a change notice as shown in FIG. 9 from the change managing part 41, the transmission control part 44 starts the following operations.

In step S30, the transmission control part 44 acquires notice information contained in the received change notice.

To take the change notice shown in FIG. 9 as an example, the transmission control part 44 acquires information indicating that the program code is 0001, the area is Tokyo, and the genre allocation of the music is JAZZ:ROCK:TECNO=2:1:1.

The process proceeds from step S30 to step S31, in which the transmission control part 44 acquires a commercial scheduled to be broadcasted in a program corresponding to the program code, and the number of times that the commercial is scheduled to be broadcasted from the commercial storing part 47.

For example, a default genre (e.g. TECHNO) is set to a commercial, and the transmission control part 44 acquires information indicating that the program code: 0001, the commercial code: 10005, the BGM genre: TECHNO, the track code: 4085, and the number of times to be broadcasted: 12 times and the like from the commercial storing part 47.

The process proceeds from step S31 to step S32, in which the transmission control part 44 selects information on a commercial that uses BGM of the specified genre from the commercial material DB 64 based on the genre allocation acquired in step S30.

FIG. 11 shows an example of a table of the commercial material DB 64.

The commercial material DB 64 includes the table shown in FIG. 11. The table contains items such as commercial code, advertiser, BGM genre, BGM name, and track code.

A cell for the track code stores an ID code for identifying music.

A cell for the advertiser stores an advertiser name that provides the commercial.

A cell for the BGM genre stores a BGM genre of the commercial.

A cell for the BGM name stores the name of the BGM.

A cell for the track code stores an ID code for identifying the BGM.

For example, in step S32 in FIG. 10, the transmission control part 44 selects a version (commercial code 10003) in which JAZZ is used as the BGM, a version (commercial code 10002) in which ROCK is used as the BGM, and a version (commercial code 10005) in which TECHNO is used as the BGM from commercials with different BGMs prepared by the advertiser of the commercial as shown in FIG. 11.

The process proceeds from step S32 to step S33, in which the transmission control part 44 stores the commercials selected in step S32 into the commercial storing part 47 based on the genre allocation acquired in step S30.

For example, if the commercial with the commercial code: 10005 is originally scheduled to be broadcasted 12 times, the transmission control part 44 stores the commercial with the commercial code 10003 (BGM: JAZZ) so as to be broadcasted 6 times, the commercial with the commercial code 10002 (BGM: ROCK) 3 times, and the commercial with the commercial code 10005 (BGM: TECHNO) 3 times in the commercial storing part 47.

For rounding fractions appearing in the allocation, e.g., if the commercial with the commercial code: 10005 is originally scheduled to be broadcasted 10 times, the priority may be given to the commercial for which BGM has the highest allocation. In this case, the transmission control part 44 stores the commercial with the commercial code 10003 (BGM: JAZZ) so as to be broadcasted 6 times, the commercial with the commercial code 10002 (BGM: ROCK) 3 times, and the commercial with the commercial code 10005 (BGM: TECHNO) 3 times in the commercial storing part 47.

The commercial/program output managing part 49 broadcasts the commercials stored in the commercial storing part 47 according to the schedule (e.g. JAZZ: 3 times, ROCK: 3 times, and TECHNO: 3 times).

These operations shown in FIG. 10 are thus performed to reflect music preference information on the area basis, and broadcast a commercial with BGM that matches preference of users in the area.

The BGM of the commercial can be changed until just before the commercial is broadcasted, so that the latest preference information of the users is reflected in the BGM of the commercial to be broadcasted.

### Second Embodiment

### Individual User

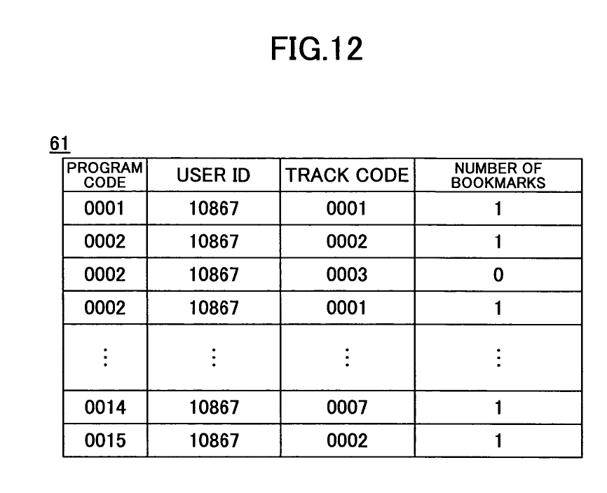

Another example of the bookmark DB 61 is provided below with reference to FIG. 12.

FIG. 12 shows another example of the table of the bookmark DB 61.

The bookmark DB 61 includes the table shown in FIG. 12. The table contains items such as program code, user ID, track code, and the number of bookmarks.

A cell for the program code stores an ID code for identifying a program during which music is broadcasted.

A cell for the user ID stores an identifier for identifying a user who watches a broadcast.

A cell for the track code stores an ID code for identifying music.

A cell for the number of bookmarks stores the number of pieces of bookmark information.

As shown in FIG. 12, the change managing part 41 counts the number of pieces of bookmark information with respect to program codes, user IDs and track codes, and stores the result in the bookmark DB 61.

Associating the number of bookmarks with the program code makes it possible to know music preferences of each user, change BGM of a commercial to be broadcasted on the user basis, and broadcast the commercial.

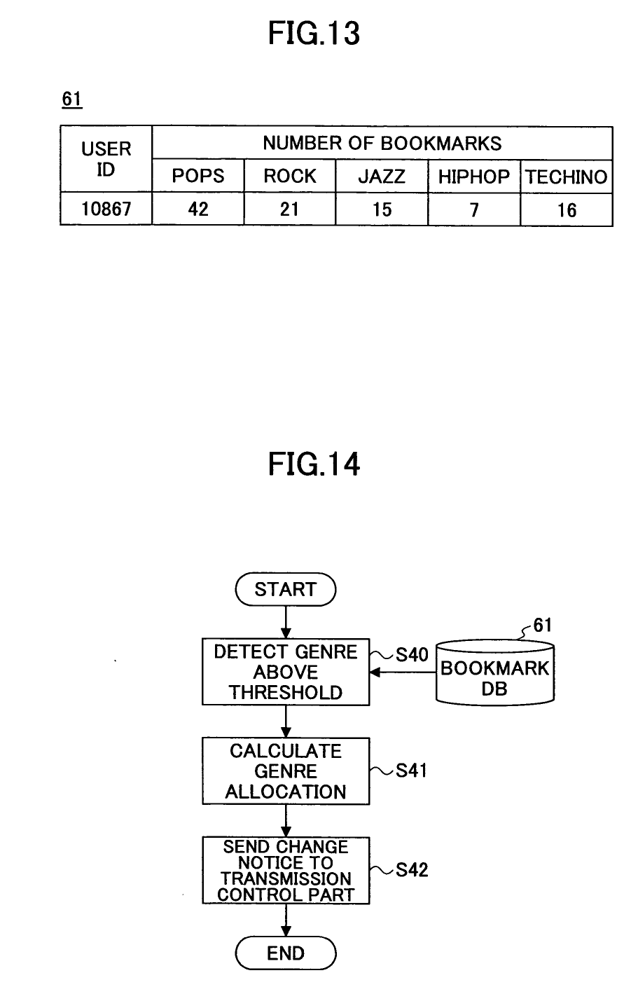

Still another example of the table of the bookmark DB 61 is provided below with reference to FIG. 13.

FIG. 13 shows still another table of the bookmark DB 61, storing the bookmark information accumulated for a certain period (e.g. one month) and classified by the change managing part 41.

The bookmark DB 61 includes the table shown in FIG. 13. The table contains items such as user ID, and the number of bookmarks per genre.

A cell for the user ID stores an identifier for identifying a user who watches a broadcast.

A cell for the number of bookmarks stores the number of bookmarks per genre.

The change managing part 41 classifies music into genres based on bookmark information accumulated for a certain period (e.g. one month) with reference to the music list DB 63, and stores the number of bookmarks in the table shown in FIG. 13.

An example of operations for detecting a genre above a threshold is provided below with reference to FIG. 14.

FIG. 14 is a flowchart showing an example of above-threshold genre detecting operations.

In step S40, the change managing part 41 detects a genre above a threshold from the bookmark DB 61.

The threshold is set based on information, which may be acquired by the change managing part 41, such as direct inputs from the operator of the broadcasting apparatus 1, or threshold information defined in a threshold definition file.

For instance, when the threshold is “genre with 20 or more bookmarks”, the change managing part 41 searches the table shown in FIG. 13 based on this threshold as a search condition and acquires a genre with 20 or more bookmarks. In the case of the table shown in FIG. 13, POPS and ROCK are detected as above-threshold genres.

The process proceeds from step S40 to step S41, in which the change managing part 41 calculates the genre allocation of the above-threshold genre based on the genre information acquired in step S40 and the number of bookmarks.

For example, when the number of bookmarks of POPS is 42 and ROCK is 21 in step 40, the genre allocation calculated by the change managing part 41 is POPS:ROCK=2:1.

The process proceeds from step S41 to step S42, the change managing part 41 transmits a change notice that directs a BGM change for a commercial to the transmission control part 44.

These operations shown in FIG. 14 are thus performed to detect a genre above a threshold on a user basis, calculate the genre allocation, and inform the transmission control part 44 of a BGM change for a commercial.

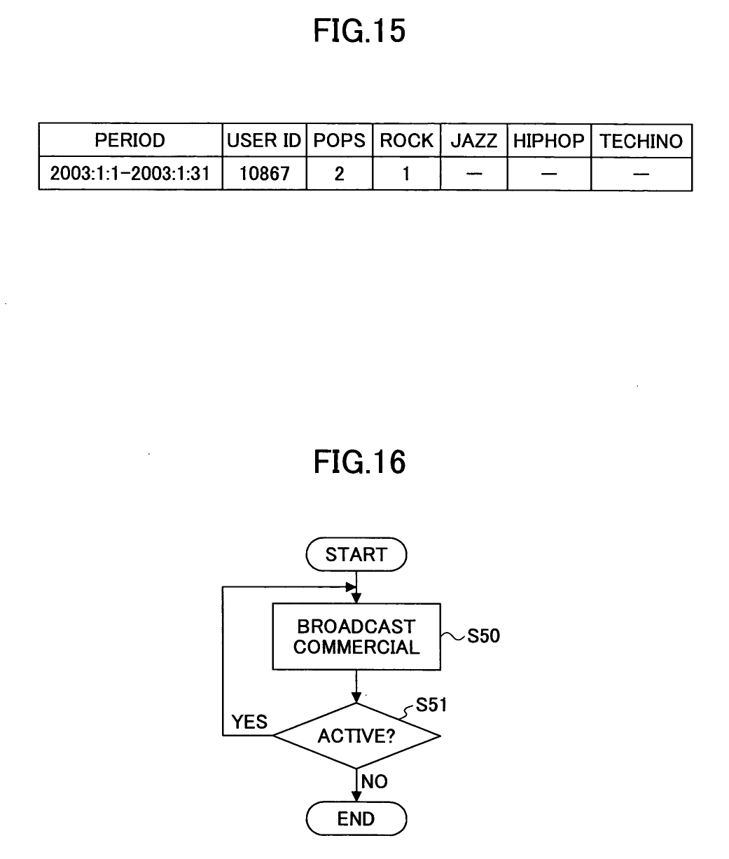

Another example of the change notice is provided below with reference to FIG. 15.

FIG. 15 shows another example of the change notice.

The change notice shown in FIG. 15 contains a period of time, a user ID for whom a commercial is changed, and a genre allocation of music.

BGM changing operations in the second embodiment are generally the same as those in the first embodiment shown in FIG. 10. The difference is that, in the second embodiment, all the BGMs of commercials to be broadcasted to a target user are changed based on the genre allocation shown in the change notice in FIG. 15.

In the second embodiment, since the commercials are broadcasted with BGM changed on the user basis, the broadcasting apparatus 1 may determine whether the broadcast receiver 2 of the user is active at the time of broadcasting the commercials.

An example of broadcasting a commercial to a user is provided below with reference to FIG. 16.

FIG. 16 shows an example of a commercial broadcast.

The commercial/program output managing part 49 starts the following operations upon receiving information indicating that the broadcast receiver 2 is active from the change managing part 41 or the like.

The commercial/program output managing part 49 broadcasts commercials of which BGM are changed based on bookmark information stored in the commercial storing part 47 according to a schedule and a specified allocation.

In the case of the examples shown in FIG. 14 and FIG. 15, a commercial with POPS BGM and a commercial with ROCK BGM are broadcasted according the allocation of 2:1.

The process proceeds from step S50 to step S51, in which the commercial/program output managing part 49 determines whether the broadcast receiver 2 is active. If the commercial/program output managing part 49 determines that the broadcast receiver 2 is active (if YES in step S51), the operation returns to step S50. Otherwise, if the commercial/program output managing part 49 determines that the broadcast receiver 2 is not active (if No in step S11), the operations are ended.

For instance, when the commercial/program output managing part 49 receives information indicating that the broadcast receiver 2 is not active from the change managing part 41, the commercial/program output managing part 49 determines that the broadcast receiver 2 is not active.

These operations shown in FIG. 16 are thus performed to more efficiently broadcast a commercial with BGM that matches the preference of a user.

1. An advertisement managing method for a broadcasting apparatus to transmit a broadcast, comprising:
a data acquisition information receiving step receiving, from a broadcast receiver, data acquisition information about an acquisition of data relating to music contained in the broadcast by the broadcast receiver;
a preference information accumulating step accumulating the data acquisition information received in the data acquisition information receiving step as music preference information of a viewer; and
a background music changing step changing background music of an advertisement based on the preference information prior to broadcasting the advertisement.

2. The advertisement managing method as claimed in claim 1, further comprising a preference information detecting step detecting one or more pieces of preference information above a predetermined threshold from the preference information accumulated in the preference information accumulating step.

3. The advertisement managing method as claimed in claim 2, further comprising a genre allocation calculating step calculating music genre allocation based on the one or more pieces of preference information detected in the preference information detecting step.

4. The advertisement managing method as claimed in claim 3, wherein the background music changing step is adapted to change the background music of the advertisement according to the genre allocation calculated in the genre allocation calculating step.

5. The advertisement managing method as claimed in claim 2, wherein the threshold is set for the music.

6. The advertisement managing method as claimed in claim 2, wherein the threshold is set for the genre of the music.

7. The advertisement managing method as claimed in claim 1, further comprising a preference information acquiring step acquiring the preference information from the broadcast receiver to receive the broadcast, prior to the preference information accumulating step.

8. The advertisement managing method as claimed in claim 3, further comprising an advertisement broadcasting step broadcasting the advertisement of which background music is changed in the background music changing step.

9. A broadcasting apparatus to transmit a broadcast, comprising:
a data acquisition information receiving part receiving, from a broadcast receiver to receive the broadcast, data acquisition information about an acquisition of data relating to music contained in the broadcast by the broadcast receiver;
a preference information accumulating part accumulating the data acquisition information received by the data acquisition information receiving part as music preference information of a viewer; and
a background music changing part changing background music of an advertisement based on the preference information prior to broadcasting the advertisement.

10. A computer-readable medium having an advertisement managing program executable by a computer, the program comprising:
a data acquisition information receiving step receiving, from a broadcast receiver to receive a broadcast transmitted by a broadcasting apparatus, data acquisition information, data acquisition information about an acquisition of data relating to music contained in the broadcast by the broadcast receiver;
a preference information accumulating step accumulating the data acquisition information received in the data acquisition information receiving step as music preference information of a viewer; and
a background music changing step changing background music of an advertisement based on the preference information prior to broadcasting the advertisement.
